(19) United States
(12) Patent Application Publication
(10) Pub. No.: US 2026/0287001 A1
(43) Pub. Date: Sep. 24, 2026

(54) MULTIDIMENSIONAL HYBRID LAP JOINTS AND ADDITIVE MANUFACTURING PROCESSES FOR MAKING BEZEL ASSEMBLIES

(71) Applicant: GM GLOBAL TECHNOLOGY OPERATIONS LLC, Detroit, MI (US)

(72) Inventors: Dale Miller, Rochester Hills, MI (US); James J. Deininger, Wyandotte, MI (US); Joel Jefford, Windsor (CA); Raffaello Ardanese, Bloomfield Hills, MI (US); Jungkee Kwon, Lake Orion, MI (US)

(73) Assignee: GM GLOBAL TECHNOLOGY OPERATIONS LLC, Detroit, MI (US)

(21) Appl. No.: 19/084,841

(22) Filed: Mar. 20, 2025

(51) Int. Cl. F16B 21/06; B33Y 80/00

(52) U.S. Cl. CPC F16B 21/06; B33Y 80/00

(57) ABSTRACT

Presented are multidimensional, hybrid lap joints for assembling multipart components, methods for making/using such lap joints, and bezel assemblies fabricated with such lap joints. A multipart assembly contains first and second parts, each including a part body, a part leg projecting from the part body, and lap joint (LJ) section projecting from a terminal end of each leg. One LJ section includes multiple mutually non-coplanar LJ walls with multiple snap-lock (SL) protrusions projecting outward from the LJ walls. The other LJ section includes multiple mutually non-coplanar LJ walls with multiple pairs of SL teeth projecting inward from the LJ walls. The walls of one LJ section slidably receive therein and interference fit with the walls of the other LJ section. Additionally, each pair of SL teeth receives therebetween and snap fits with a respective one of the SL protrusions to lock the first part to the second part.

### INTRODUCTION

The present disclosure relates generally to features and methods for joining the parts of a multipart assembly. More specifically, aspects of this disclosure relate to structural joints and manufacturing processes for fabricating bipartite bezel assemblies.

Additive manufacturing refers to computer-aided fabrication processes for creating three-dimensional (3D) objects from a digital model by sequentially depositing material, typically layer by layer, within a confined work envelope. One of the biggest advantages of additive manufacturing (AM)—more commonly known as “3D printing”—is the ability to use a single “printing” tool to produce objects in countless shapes and sizes, including those with complex geometries and internal void spaces, without the attendant material waste, design limitations, and retooling expenses associated with traditional fabrication techniques. Various additive manufacturing processes are known, differing primarily in the materials being used and in the manner in which material is deposited. For instance, AM processes may use an assortment of starting materials, such as thermoplastic filaments, metal powders, polymer blends, resins, and concrete, and a variety of different printing processes, such as fused deposition modeling, laser sintering, electron beam melting, and inkjet 3D printing, to form a part.

Additive manufacturing is increasingly being used in the mass production of assorted components and component parts, like bezels, housings, and brackets, especially in the electronics, automotive, and aviation industries. AM processes allow for precise and customizable designs, enabling manufacturers to produce components with elaborate features and intricate details that would be expensive and time consuming to produce with standard molding techniques. Using materials like metal, plastic, and composite polymers, AM enables faster prototyping and shorter production cycles, leading to reduced process lead times. This technology also minimizes material waste, enhancing sustainability while ensuring high-quality output at scale. However, AM's layer-by-layer approach may be too slow for high-volume production, offering limited scalability and reduced efficiencies. Part sizes are heavily constrained by the build volume of the 3D printer, and many 3D-printed parts need post-processing to improve their mechanical properties and surface finishes.

### SUMMARY

Presented herein are multidimensional, hybrid lap joints for assembling multipart components, methods for manufacturing and methods for using such lap joints, and multipart bezel assemblies fabricated with such lap joints. By way of example, and not limitation, a light fixture bezel may be fabricated as a bipartite construction with a rounded-rectangular geometry that may be defined by two interconnectable U-shaped end sections. The terminal ends of the legs of one U-shaped section may each have a first “male” half of a lap joint (LJ), and the terminal ends of the legs of the other U-shaped section may each have a second “female” half of the LJ. The first LJ half has a first U-shaped transverse cross-section defined by multiple adjoining walls that are mutually non-coplanar. One or more snap-lock (SL) protrusions project outward from each of the LJ walls. The second LJ half has a second U-shaped transverse cross-section defined by multiple adjoining walls that are mutually non-coplanar. The second U-shaped cross-section is complementary to, but slightly larger than, the first U-shaped cross-section such that the first LJ half may be pressed into and friction fit with the second LJ half. In addition, the second LJ half has at least one pair of flexible snap-lock teeth that projects inward from each of its LJ walls. Each pair of SL teeth receives therebetween and snap-locks to a respective one of the protrusions when the first LJ half is pressed into the second LJ half and thereby joins together the two U-shaped end sections.

The foregoing bezel design features allow the bezel assembly parts to be printed, snaped together, glued, painted, and installed with minimal effort and without specialized tooling. The novel hybrid lap joint may be typified by integrally formed interference-fit and snap-lock elements that facilitate aligning, locating, and joining the constituent parts of the bezel during the assembly process. An inboard-facing (Class B) surface of the bezel assembly may be integrally formed with a network of structural reinforcement ribs that help to prevent the bezel parts from bending, buckling, or losing structural integrity during printing, assembly and installation. The bezel assembly may take on a modular design that allows multiple sections to be printed and assembled, which enables bezels of different sizes to be printed. The multipart bezel design also enables the use of 3D printing technologies that may otherwise be unable to print unitary bezel geometries due to size constraints with the printer's internal build volume.

Aspects of this disclosure are directed to multidimensional, hybrid lap joints for assembling multipart components. In an example, a multipart assembly is composed of at least two constituent parts: (1) a first part with a part body, a leg projecting from the part body, and a first lap joint section located at a terminal end of the leg; and (2) a second part with a part body, a leg projecting from the part body, and a second lap joint section located at a terminal end of the leg. The first LJ section includes multiple mutually non-coplanar LJ walls and multiple snap-lock protrusions that project outward from the LJ walls. Likewise, the second LJ section includes multiple mutually non-coplanar LJ walls and multiple pairs of snap-lock teeth that project inward from these LJ walls. The walls of the second LJ section collectively define a lap joint channel that slidably receives therein and interference fits with the walls of the first LJ section. In tandem, each pair of SL teeth of the second LJ section receives therebetween and snap fits with a respective SL protrusion to thereby lock the first part to the second part. Disclosed lap joint designs may be integrated into any logically relevant type of multipart assembly, including bezels, frames, housings, etc., and may be implemented for automotive and non-automotive applications alike.

Additional aspects of this disclosure are directed to bezel assemblies, such as light fixture bezels for motor vehicles or towable cargo trailers. In an example, a light fixture bezel assembly includes first and second U-shaped parts, each of which is integrally formed as a respective one-piece structure with a curvilinear part body, a pair of rectilinear legs projecting from opposing ends of the part body, and a lap joint section located at the terminal end of each leg. Each LJ section includes multiple adjoining and mutually non-coplanar LJ walls, e.g., that collectively define a U-shaped transverse cross-section. The LJ sections of the first U-shaped part each includes multiple snap-lock protrusions that project outward from the LJ walls. Similarly, each LJ section of the second U-shaped part includes multiple pairs of SL teeth projecting inward from the LJ walls. The LJ walls of each LJ section of the second U-shaped part collectively define a lap joint channel that is shaped and sized to slidably receive therein and interference fit with the LJ walls of a respective one of the LJ sections of the first U-shaped part. Moreover, each pair of SL teeth receives therebetween and snap fits with a respective one of the SL protrusions to thereby lock the first part to the second part.

Aspects of this disclosure are directed to methods for making and methods for using any of the herein described multipart assemblies with multidimensional, hybrid lap joints. In an example, a method is presented for manufacturing a multipart assembly. This representative method includes, in any order and in any combination with any of the above and below disclosed options and features: printing, e.g., from a polymeric material using an additive manufacturing process, a first part including a first part body with a first leg projecting from the first part body, the first leg including a first terminal end with a first lap joint (LJ) section, the first LJ section including multiple mutually non-coplanar first LJ walls and multiple snap-lock (SL) protrusions projecting outward from the first LJ walls; printing, e.g., from a polymeric material using the AM process, a second part including a second part body with a second leg projecting from the second part body, the second leg including a second terminal end with a second LJ section, the second LJ section including multiple mutually non-coplanar second LJ walls and multiple pairs of SL teeth projecting inward from the second LJ walls, the second LJ walls collectively defining a lap joint channel; sliding the first LJ walls into the lap joint channel defined by the second LJ walls to thereby interference fit the first LJ section with the second LJ section; and, pressing a respective one of the SL protrusions into each of the pairs of SL teeth to thereby snap fit the first LJ section with the second LJ section and join the first and second parts.

For any of the disclosed multipart assemblies, light fixture bezels, and methods, the LJ walls of each lap joint section may include a pair of sidewalls that each projects from a respective end of a center wall. In this instance, the center wall of the first LJ section abuts the center wall of the second LJ section while the sidewalls of the first LJ section each abuts a respective sidewall of the second LJ section when the first LJ section interference fits with the second LJ section. As a further option, the LJ section sidewalls may be substantially parallel to each other and substantially orthogonal to the their center wall. Moreover, the SL protrusions may include three distinct sets of SL protrusions, a first set that projects from the center wall, a second set that projects from one sidewall, and a third set that projects from the other sidewall. Likewise, the pairs of SL teeth may include three sets of SL teeth pairs, a first set that projects from the center wall, a second set that projects from one sidewall, and a third set that projects from the other sidewall. In this instance, the three sets of SL protrusions may be arranged in mutually parallel rectilinear rows, and the three sets of SL teeth pairs may be arranged in mutually parallel rectilinear rows, with each row of protrusions being substantially aligned and coterminous with a respective row of teeth.

For any of the disclosed multipart assemblies, light fixture bezels, and methods, each SL protrusion may have an elongated asymmetrical I-beam shape (e.g., I-beam rail with a wide base, a narrow web, and a rounded head), and each SL tooth may have an elongated arcuate shape (e.g., ratchet-gear shaped flexible tooth). As a further option, each of the assembly parts may include a set of structural reinforcement ribs, e.g., that are integrally formed with an underside surface of the part body. Each set of structural reinforcement ribs may include multiple semicylindrical-shaped rib rails. Additionally or alternatively, each set of structural reinforcement ribs may include a network of hexagonal “honeycomb-shaped” reinforcement ribs. Adhesive may be applied to the mating lap joint sections, e.g., by creating a ‘staggered lap joint on part ribs’that adds a significant amount of wetted surface area to the bond.

For any of the disclosed multipart assemblies, light fixture bezels, and methods, one of the assembly parts may include a semicylindrical flange that projects axially from the terminal end of each leg (e.g., extending longitudinally past the lap joint section). In this instance, the terminal end of each leg of the other assembly part may include a semicylindrical pocket (e.g., recessed in from the lap joint section) that slidably receives therein and interference fits with a respective one of the semicylindrical flanges. It may be desirable that each assembly part, including its respective body, leg(s), and the LJ section(s), be integrally formed as a single-piece structure, e.g., from a rigid and resilient polymeric material. Each part body may include a curvilinear web and a pair of rectilinear legs that each projects from a respective end of the curvilinear web.

The above summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is an exploded, topside perspective-view illustration of a representative multipart bezel assembly with multidimensional, hybrid lap joints for connecting the constituent parts of the bezel assembly in accord with aspects of the present disclosure.

FIG. 2 is an enlarged, topside perspective-view illustration of a first “male” half of the representative lap joints of FIG. 1.

FIG. 3 is an enlarged, underside perspective-view illustration of a second “female” half of the representative lap joints of FIG. 1.

FIG. 4 is an underside, perspective-view illustration of a U-shaped end section of a representative bezel assembly with a network of semicylindrical structural reinforcement ribs in accord with aspects of the present disclosure.

FIG. 5 is an underside, perspective-view illustration of a U-shaped end section of another representative bezel assembly with a network of honeycomb-shaped structural reinforcement ribs in accord with aspects of the present disclosure.

The present disclosure is amenable to various modifications and alternative forms, and some representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, Brief Description of the Drawings, and Detailed Description sections, but not explicitly set forth in the claims, should not be incorporated into the claims, singly or collectively, by implication, inference or otherwise. Moreover, recitation of “first”, “second”, “third”, etc., in the specification or claims is not per se used to establish a serial or numerical limitation; unless specifically stated otherwise, these designations may be used for ease of reference to similar features in the specification and drawings and to demarcate between similar elements in the claims.

For purposes of this disclosure, unless specifically disclaimed: the singular includes the plural and vice versa (e.g., indefinite articles “a” and “an” should generally be construed as meaning “one or more”); the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein to denote “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, node, vertical, horizontal, upward, downward, front, back, left, right, etc., may be with respect to a motor vehicle, such as a forward driving direction of a motor vehicle when the vehicle is operatively oriented on a horizontal driving surface.

Discussed below are multipart assemblies, such as bipartite light fixture bezels, with integral snap-locking, friction-fitting lap joint features and integral structurally reinforcing rib features. These design features enable the use of 3D-printing techniques to form the constituent parts of the assembly and, in so doing, reduce the time and expenses associated with attendant product development and manufacturing processes. Once printed, the constituent parts may be easily assembled, painted, and installed without sacrificing the parts'structural integrity and surface quality. By segmenting a unitary component into multiple interconnectable parts, disclosed designs allow the use of 3D-printing technologies that normally cannot be used to print large scale parts due to size constraints with the printer's internal work envelope. Additionally, disclosed multipart assemblies enable the use of a variety of different types of rib and joint features that allow for rapid production and on-demand customization. The total length of the bezel, for example, can be increased by adding compatible leg-extension sections that interconnect with each other and with the U-shaped end sections using complementary lap joints.

Disclosed multipart assemblies enable the use of 3D printing to fabricate its constituent parts which, in turn, enables real-time design changes and rapid prototyping that would not otherwise be possible due to tooling limitations and fixed mold constraints of conventional molding and machining processes. Total assembly footprint may be rapidly increased or decreased, for example, through the addition or subtraction of intermediate sections and/or variations to individual part dimensions. Integral structural reinforcement ribs help to prevent bending and structural defects that may be caused during printing due to thermal warpage caused by rapid polymer heating and cooling. The mating geometry of the lap joint enables the application of adhesive to the joint by creating a ‘staggered lap joint on part ribs’, which adds a significant amount of surface area to the bond. Enabling the use of 3D printing concomitantly allows for the addition of reinforcement ribs with complex geometries, including undercuts and honeycomb-shaped ribs that provide structural integrity during the printing process to avoid thermal defects.

Herein-described multipart assemblies may be finished and painted using current production painting processes, including both matte and glossy finishes, thus providing more design flexibility and carryforward costs savings. Using specialized post-processing techniques, for example, the assembly may be painted even though the surfaces of the raw printed parts may suffer from poor roughness, porosity, or defects caused by the 3D printing process. Different 3D-printing technologies and printing materials may be used to fabricate any given multipart assembly. For example, multi-jet fusion (MJF) and selective laser sintering (SLS) technologies may be used to print parts from polypropylene (PPU) or aluminum, which allows for simplified customization of the final product. Using different materials for a section may help to reduce costs, increase development speed, and allow for different post-processing technologies, such as adding CMYK colors. Disclosed designs may also allow the individual parts to be printed at a desired angle (e.g., 15-degree angle) to enable the parts to have a better surface finish and avoid thermal degradation and bending that may be caused by the AM process.

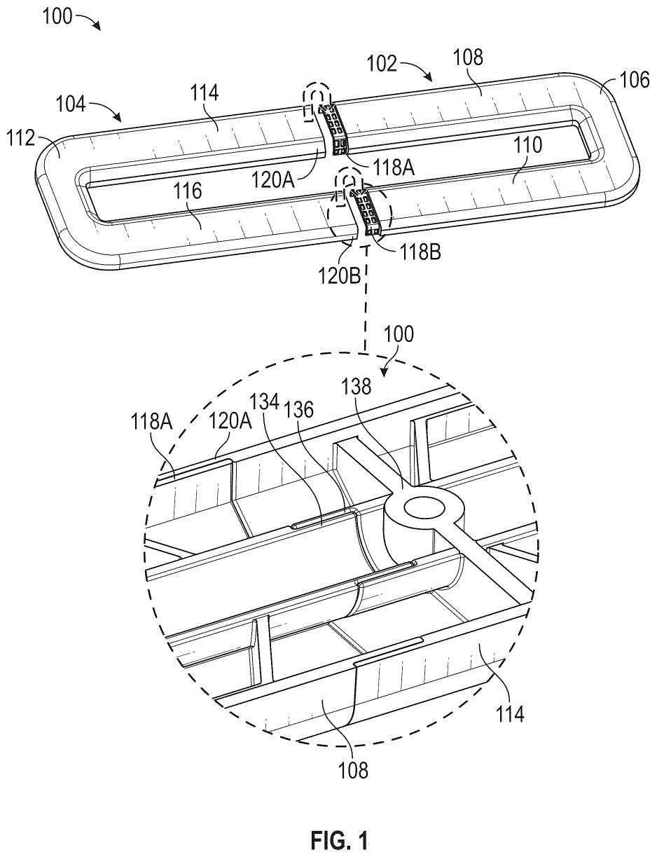

Referring now to the drawings, wherein like reference numbers refer to like features throughout the several views, there is shown in FIG. 1 a representative multipart assembly, which is designated generally at 100 and portrayed herein for purposes of discussion as a 3D-printed, bipartite light fixture bezel. The illustrated light fixture bezel 100—also referred to herein as “multipart assembly” or “bezel” for short—is merely an exemplary application with which novel aspects of this disclosure may be practiced. In the same vein, incorporation of the present concepts into a light fixture bezel for a towable trailer of a motor vehicle should also be appreciated as a non-limiting implementation of disclosed features. As such, it will be understood that novel features of this disclosure may be incorporated into other bezel designs, may be utilized for any logically relevant type of multipart assembly, and may be employed for both automotive and non-automotive applications alike.

The representative multipart assembly 100 of FIG. 1 is portrayed as a bipartite light bezel with a rounded-rectangular geometry that is defined by or, if desired, consists essentially of two interconnectable parts, namely a first (right or top) U-shaped end part 102 that connects with a second (left or bottom) U-shaped end part 104. The first U-shaped part 102 may be typified by a respective (first) part body 106 with a respective pair of (first) legs 108 and 110 that project from the first part's body 106. Likewise, the second U-shaped part 104 may be typified by a respective (second) part body 112 with a respective pair of (second) legs 114 and 116 that project from the second part's body 112. Located at a terminal (leftmost) end of each of the first part's legs 108, 110 is a respective (first or male) lap joint (LJ) section 118A and 118B, which securely mates with a respective (second or female) lap joint section 120A and 120B located at a terminal (rightmost) end of each of the second part's legs 114, 116. In accord with the illustrated example, the first U-shaped end part 102, including its respective body 106, legs 108, 110, and LJ sections 118A, 118B, is integrally formed as a single-piece, unitary structure from a rigid and resilient polymeric or metallic material. In the same vein, the second U-shaped end part 104, including its respective body 112, legs 114, 116, and LJ sections 120A, 120B, may be integrally formed as a distinct single-piece, unitary structure from a similar or different material. It is envisioned that the multipart assembly 100 may take an assortment of different shapes, sizes, and materials, and may include greater than the two illustrated segments.

For simplicity of design and manufacture, the bezel's two U-shaped end parts 102, 104 of FIG. 1 may be substantially structurally identical to each other, with the exception of their individual lap joint geometries. Both of the bezel assembly's part bodies 106, 112, for example, may extend between and interconnect their respective legs 108, 110, 114, 116. The first U-shaped part's body 106 is shown having a cavitated curvilinear web structure with a C-shaped plan-view profile. Each of the legs 108, 110 may be a cavitated rectilinear structure that has a rectangular plan-view profile and projects from a respective opposing end of the body's 106 curvilinear web. The first part's legs 108, 110 may be substantially parallel to each other and substantially perpendicular to the part body 106. Similar to the part body 106, the second U-shaped part's body 112 may have a cavitated curvilinear web structure with a C-shaped plan-view profile. Each leg 114, 116 may be a cavitated rectilinear structure that has a rectangular plan-view profile and projects from a respective opposing end of the body's 112 curvilinear web. The second part's legs 114, 116 may be substantially parallel to each other, substantially perpendicular to part body 112, and coplanar to the first part's legs 108, 110.

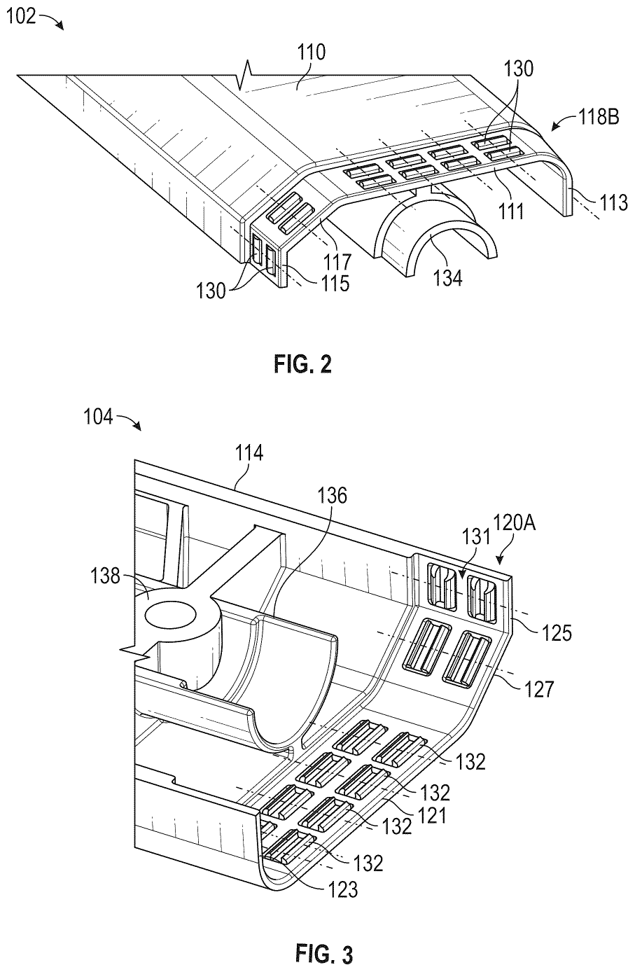

To quickly and securely assemble the light fixture bezel 100, the bezel's two mating parts 102, 104 may be fabricated with complementary lap joint halves that friction-fit and snap-lock together, e.g., without the need for fasteners, welding, or specialized tools. As best seen in FIG. 2, for example, each of the male LJ sections 118B may be defined, in part, by a series of adjoining, mutually non-coplanar (first) walls that define a generally U-shaped (concave) transverse cross-section. These LJ walls may include a center wall 111 with two sidewalls 113 and 115 that each projects from a respective opposing end of the center wall 111. The two sidewalls 113, 115 may be substantially parallel to each other and substantially orthogonal to the center wall 111. The center wall 111 may have an optional ramped wall segment 117 that extends at an oblique angle between the second sidewall 115 and a horizontal segment of the center wall 111. FIG. 2 only shows the lap joint section 118B of the right bezel section's second leg 110; it should be appreciated, however, that the lap joint section 118A of the first leg 108 may be a structurally identical, mirrored counterpart to the lap joint section 118B shown in FIG. 2.

FIG. 3 shows that each of the female LJ sections 120A, 120B may be defined, in part, by a series of adjoining, mutually non-coplanar (second) walls that define a generally U-shaped (concave) transverse cross-section. These LJ walls may include a center wall 121 with two sidewalls 123 and 125 that each projects from a respective opposing end of the center wall 121. The two sidewalls 123, 125 may be substantially parallel to each other and substantially orthogonal to the center wall 121. Moreover, the center wall 121 may have an optional ramped wall segment 127 that extends at an oblique angle between the second sidewall 125 and a horizontal segment of the center wall 121. As will be explained below, the adjoining walls 121, 123, 125 of each female LJ section 120A, 120B collectively define a lap joint channel 131 that slidably receives therein and thereby interference fits with the walls 111, 113, 115 of its mating male LJ section 118A, 118B. FIG. 3 only shows the lap joint section 120A of the left bezel section's first leg 114; it should be appreciated, however, that the lap joint section 120B of the second leg 116 may be a structurally identical, mirrored counterpart to the lap joint section 120A shown in FIG. 3. It is also envisioned that the shape, size, and number of associated wall segments of each LJ section 118A, 118B, 120A, 120B may be varied from that which are shown in the drawings.

The concave, U-shaped cross-section of each female LJ section 120A, 120B is complementary to, but slightly larger than, the U-shaped cross-section of its mating male LJ section 118A, 118B such that the female LJ section 120A, 120B may be pressed onto and friction fit with its respective male LJ section 120A, 120B. Using hidden-lined arrows, FIG. 1 portrays the LJ sections 118A, 118B of the left bezel part 104 being aligned vertically above and then pushed down onto the LJ sections 118A, 118B of the right bezel part 102. In tandem, or alternatively, the male LJ sections 118A, 118B may be aligned with and pressed into their respective female LJ sections 120A, 120B. In so doing, each female LJ section 120A, 120B slides, e.g., vertically downward in FIG. 1, against its respective male LJ section 118A, 118B and thereby creates an interference-fit-type mechanical joint between the two end parts 102, 104. When fully seated, the center wall 121 and sidewalls 123, 125 of each female LJ section 120A, 120B may abut and, if desired, sit generally flush against the center wall 111 and sidewalls 113, 115, respectively, of its mating male LJ section 118A, 118B.

In addition to providing a friction-fit connection between the bezel's two complementary parts 102, 104, the mating lap joint halves also include snap-lock features that cooperatively create a snap-fit-type mechanical joint for assembling the bezel 100. With reference again to FIG. 2, each of the male LJ sections 118A, 118B may be fabricated with a predefined pattern of snap-lock (SL) protrusions 130 that project outward from the LJ walls 111, 113, 115, 117. While only four protrusions are labelled in FIG. 2, each male LJ section 118A, 118B is illustrated as having fourteen (14) total SL protrusions 130. In accord with the illustrated example, a first set of eight (8) SL protrusions 130 projects outward from the center wall 111, a second set of two (2) SL protrusions 130 projects transversely outward from the first sidewall 113, a third set of two (2) SL protrusions 130 projects transversely outward from the second sidewall 115, and a fourth set of two (2) SL protrusions 130 projects outward from the ramped wall segment 117. The four sets of SL protrusions 130 may be arranged in a 3D rectangular array of mutually parallel, rectilinear rows (e.g., seven total rows designated in FIG. 2 with dash-dot-dash lines). The SL protrusions 130 may each have an elongated, asymmetrical I-beam shape, namely an I-beam rail with a wide base adjoining the LJ wall, a narrow web projecting out from the base, and a rounded cylindrical head at a distal end of the web. Each male LJ section 118A, 118B may incorporate greater or fewer than fourteen protrusions 130, which may take on alternative form factors and may be arranged in any desired pattern depending on the intended application and attendant design constraints, for example.

With reference again to FIG. 3, each female LJ section 120A, 120B may be fabricated with a predefined pattern of SL teeth pairs 132 that project inward from the LJ walls 121, 123, 125, 127. While only four pairs of SL teeth are labelled in FIG. 3, each female LJ section 120A, 120B is illustrated as having fourteen (14) total pairs of teeth 132. Consistent with the arrangement of the SL protrusions 130, a first set of eight (8) pairs of SL teeth 132 projects inward from the center wall 121, a second set of two (2) pairs of SL teeth 132 projects transversely inward from the first sidewall 123, a third set of two (2) pairs of SL teeth 132 projects transversely inward from the second sidewall 125, and a fourth set of two (2) pairs of SL teeth 132 projects inward from the ramped wall segment 127. Also coincident with the SL protrusions 130, the four sets of SL teeth pairs 132 may be arranged in a 3D rectangular array of mutually parallel, rectilinear rows (e.g., seven total rows designated in FIG. 3 with dash-dot-dot-dash lines). Each SL tooth within the pairs of SL teeth 132 may have an elongated arcuate shape, namely a curved ratchet-gear shaped flexible tooth. With in each pair, the tips of the two arcuate teeth may point towards each other. Like the male LJ sections 118A, 118B, each female LJ section 120A, 120B may incorporate greater or fewer than fourteen pairs of teeth 132, which may take on alternative shapes, sizes, and arrangements from the illustrated example.

When the male LJ sections 118A, 118B are operatively engaged with the female LJ sections 120A, 120B, each pair of SL teeth 132 receives therebetween and snap-locks to a respective one of the protrusions 130 to thereby mechanically join the two U-shaped end parts 102, 104 of the bezel assembly 100. By aligning and pressing together the male and female LJ sections 118A, 118B, 120A, 120B, for example, the rounded heads at the distal ends of the SL protrusions 130 are moved into contact with the distal tips of the arcuate SL teeth 132. This causes the protrusion 130 to press against and deflect the two teeth 132 away from each other. Once the teeth 132 are sufficiently deformed to allow the protrusion 130 to pass, the protrusion 130 clears the rounded distal tips of the teeth 132; the elastic nature of the teeth 132 then causes the teeth 132 to return to their original undeformed shape. In so doing, the teeth 132 “snap back” and lock their respective protrusions 130 inside a cavity defined between the two teeth 132. The foregoing hybrid interference-fit, snap-fit lap joint design facilitates aligning, locating, and joining the constituent parts 102, 104 of the bezel 100 during the assembly process.

To help align and secure the overlapping lap joint halves, an optional semicylindrical flange 134 (FIG. 2) may project outward from the terminal end of each leg 108, 110 of the right bezel part 102, extending longitudinally past the LJ sections 118A, 118B subjacent the SL protrusions 130. Each leg 114, 116 of the left bezel part 104 may be formed with an optional semicylindrical pocket 136 (FIG. 3) that is recessed inward from the LJ section 120A, 120B and located adjacent the SL teeth 132. Each semicylindrical pocket 136 is shaped and sized to slidably receive therein and interference fits with a respective one of the semicylindrical flanges 134. The interconnectable bezel parts 102, 104 may be fabricated with fastener slots 138 for securing the bezel assembly 100 to a support structure, such as the outer wall of a towable cargo trailer.

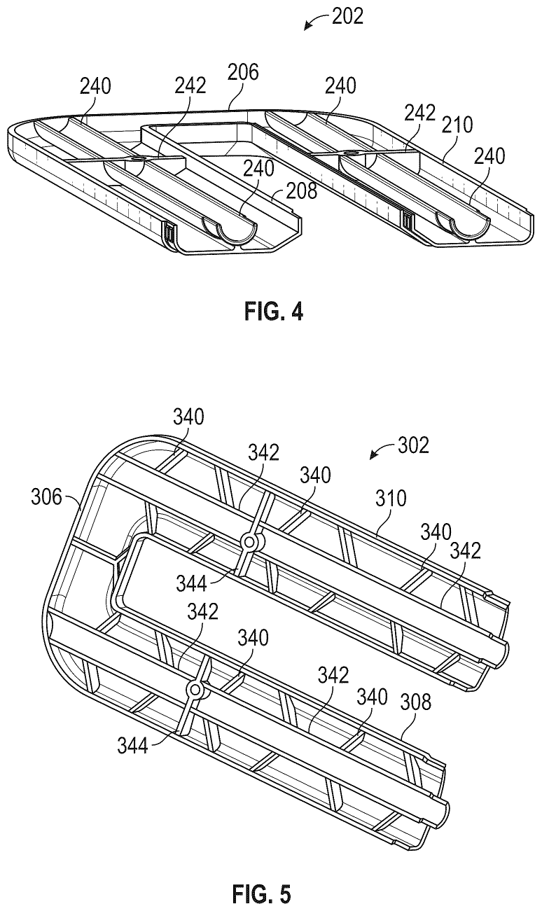

An inboard-facing (Class B) surface of the bezel assembly 100 may be integrally formed with a network of structural reinforcement ribs that helps to prevent the bezel parts 102, 104 from bending, buckling, or losing structural integrity during printing, assembly, and installation. Turning next to FIGS. 4 and 5, for example, each bezel end part 202 and 302 may include multiple wall-like ribs 240 and 340, respectively, that are integrally formed with the part body 206 and 306 and part legs 208, 210, 308 and 310. In FIG. 4, the structural reinforcement ribs 240 are shown as four (4) semicylindrical-shaped rib rails that extend longitudinally along the length of the part 202. An optional transverse rib wall 242 may be interposed between and adjoin a neighboring pair of the structural reinforcement ribs 240. Comparatively, the structural reinforcement ribs 340 of FIG. 5 are portrayed as a network of honeycomb-shaped reinforcement ribs. Similar to FIG. 4, the bezel part 302 of FIG. 5 may also include four (4) semicylindrical-shaped rib rails 342 that extend longitudinally along the length of the part 302. Likewise, an optional transverse rib wall 344 may be interposed between and adjoin a neighboring pair of the structural reinforcement ribs 342. While FIGS. 4 and 5 only show the right bezel part 202, 302 with the various structural reinforcement rib features, the left bezel part 104 may be fabricated with either or both of the proposed rib configurations.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A multipart assembly, comprising:
a first part including a first part body with a first leg projecting from the first part body, the first leg including a first terminal end with a first lap joint (LJ) section, the first LJ section including multiple mutually non-coplanar first LJ walls and multiple snap-lock (SL) protrusions projecting outward from the first LJ walls; and
a second part including a second part body with a second leg projecting from the second part body, the second leg including a second terminal end with a second LJ section, the second LJ section including multiple mutually non-coplanar second LJ walls and multiple pairs of SL teeth projecting inward from the second LJ walls,
wherein the second LJ walls collectively define a lap joint channel configured to slidably receive therein and interference fit with the first LJ walls of the first LJ section, and
wherein each of the pairs of SL teeth is configured to receive therebetween and snap fit with a respective one of the SL protrusions to lock the first part to the second part.

2. The multipart assembly of claim 1, wherein the first LJ walls include a pair of first sidewalls each projecting from a respective end of a first center wall, and the second LJ walls include a pair of second sidewalls each projecting from a respective end of a second center wall, wherein the first center wall abuts the second center wall and the first sidewalls each abuts a respective one of the second sidewalls when the first LJ walls interference fit with the second LJ walls.

3. The multipart assembly of claim 2, wherein the SL protrusions include a first set of SL protrusions projecting from the first center wall and second and third sets of SL protrusions each projecting from a respective one of the first sidewalls, and the pairs of SL teeth include a first set of SL teeth pairs projecting from the second center wall and second and third sets of teeth pairs each projecting from a respective one of the second sidewalls.

4. The multipart assembly of claim 3, wherein the first, second and third sets of SL protrusions are arranged in first mutually parallel rectilinear rows, and wherein the first, second and third sets of SL teeth pairs are arranged in second mutually parallel rectilinear rows.

5. The multipart assembly of claim 2, wherein the first sidewalls are substantially parallel to each other and substantially orthogonal to the first center wall, and the second sidewalls are substantially parallel to each other and substantially orthogonal to the second center wall.

6. The multipart assembly of claim 1, wherein each of the SL protrusions has an elongated asymmetrical I-beam shape, and wherein each SL tooth in the pairs of SL teeth has an elongated arcuate shape.

7. The multipart assembly of claim 1, wherein the first part includes a first plurality of structural reinforcement ribs integral with the first part body, and the second part includes a second plurality of structural reinforcement ribs integral with the second part body.

8. The multipart assembly of claim 7, wherein the first and second pluralities of structural reinforcement ribs each includes multiple semicylindrical-shaped rib rails.

9. The multipart assembly of claim 7, wherein the first and second pluralities of structural reinforcement ribs each includes a network of honeycomb-shaped reinforcement ribs.

10. The multipart assembly of claim 1, wherein the first part further includes a semicylindrical flange projecting from the first terminal end of the first leg, and the second part further includes a semicylindrical pocket configured to slidably receive therein and interference fit with the semicylindrical flange.

11. The multipart assembly of claim 1, wherein the first part, including the first part body, the first leg, and the first LJ section, is integrally formed as a first single-piece structure, and the second part, including the second part body, the second leg, and the second LJ section, is integrally formed as a second single-piece structure.

12. The multipart assembly of claim 1, wherein the first part body includes a first curvilinear web, and the first leg includes a first pair of rectilinear legs each projecting from a respective end of the first curvilinear web, and the second part body includes a second curvilinear web, and the second leg includes a second pair of rectilinear legs each projecting from a respective end of the second curvilinear web.

13. A light fixture bezel assembly, comprising:
a first U-shaped part integrally formed as a first single-piece structure with a first curvilinear part body and a pair of rectilinear first legs projecting from opposing ends of the first part body, each of the first legs including a first terminal end with a first lap joint (LJ) section, the first LJ section including multiple adjoining and mutually non-coplanar first LJ walls and multiple snap-lock (SL) protrusions projecting outward from the first LJ walls; and
a second U-shaped part integrally formed as a second single-piece structure with a second curvilinear part body and a pair of rectilinear second legs projecting from opposing ends of the second part body, each of the second legs including a second terminal end with a second LJ section, the second LJ section including multiple adjoining and mutually non-coplanar second LJ walls and multiple pairs of SL teeth projecting inward from the second LJ walls,
wherein the second LJ walls of each of the second LJ sections collectively define a lap joint channel slidably receiving therein and interference fitting with the first LJ walls of a respective one of the first LJ sections, and
wherein each of the pairs of SL teeth receives therebetween and snap fits with a respective one of the SL protrusions to thereby lock the first part to the second part.

14. A method of manufacturing a multipart assembly, the method comprising:
printing, using an additive manufacturing (AM) process, a first part including a first part body with a first leg projecting from the first part body, the first leg including a first terminal end with a first lap joint (LJ) section, the first LJ section including multiple mutually non-coplanar first LJ walls and multiple snap-lock (SL) protrusions projecting outward from the first LJ walls;
printing, using the AM process, a second part including a second part body with a second leg projecting from the second part body, the second leg including a second terminal end with a second LJ section, the second LJ section including multiple mutually non-coplanar second LJ walls and multiple pairs of SL teeth projecting inward from the second LJ walls, the second LJ walls collectively defining a lap joint channel;
sliding the first LJ walls into the lap joint channel defined by the second LJ walls to thereby interference fit the first LJ section with the second LJ section; and
pressing a respective one of the SL protrusions into each of the pairs of SL teeth to thereby snap fit the first LJ section with the second LJ section and join the first and second parts.

15. The method of claim 14, wherein the first LJ walls include a pair of first sidewalls each projecting from a respective end of a first center wall, and the second LJ walls include a pair of second sidewalls each projecting from a respective end of a second center wall, wherein the first center wall abuts the second center wall and the first sidewalls each abuts a respective one of the second sidewalls when the first LJ walls interference fit with the second LJ walls.

16. The method of claim 15, wherein the SL protrusions include a first set of SL protrusions projecting from the first center wall and second and third sets of SL protrusions each projecting from a respective one of the first sidewalls, and the pairs of SL teeth include a first set of SL teeth pairs projecting from the second center wall and second and third sets of teeth pairs each projecting from a respective one of the second sidewalls.

17. The method of claim 14, wherein each of the SL protrusions has an elongated asymmetrical I-beam shape, and wherein each SL tooth in the pairs of SL teeth has an elongated arcuate shape.

18. The method of claim 14, wherein the first part includes a first plurality of structural reinforcement ribs integral with the first part body, and the second part includes a second plurality of structural reinforcement ribs integral with the second part body.

19. The method of claim 14, wherein the first part, including the first part body, the first leg, and the first LJ section, is integrally formed via the AM process as a first single-piece structure, and the second part, including the second part body, the second leg, and the second LJ section, is integrally formed via the AM process as a second single-piece structure.

20. The method of claim 14, wherein the first part body includes a first curvilinear web, and the first leg includes a first pair of rectilinear legs each projecting from a respective end of the first curvilinear web, and the second part body includes a second curvilinear web, and the second leg includes a second pair of rectilinear legs each projecting from a respective end of the second curvilinear web.
